(19) United States
(12) Patent Application Publication
(10) Pub. No.: US 2009/0300532 A1
(43) Pub. Date: Dec. 3, 2009

(54) CONVEYING PRIVILEGE ESCALATION TO USERS

(75) Inventor: Crispin Cowan, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, REDMOND, WA (US)

(21) Appl. No.: 12/130,797

(22) Filed: May 30, 2008

(51) Int. Cl. G06F 3/048

(52) U.S. Cl. 715/771

(57) ABSTRACT

Techniques, systems, and apparatuses for conveying privilege escalation to a user are disclosed. In some aspects, a privilege escalation request is initiated in a first operating environment. The first operating environment may foreshorten to reveal a second operating environment associated with the privilege escalation. The second operating environment includes a continuous visual presentation to alert the user of the privilege escalation. A user may complete one or more privileged activities in the second operating environment before returning to the first operating environment.

### BACKGROUND

In today's society, many people interact with computing environments using personal computers, personal data assistants (PDA), telephones, audio/video devices, and other devices. Often, computing environments enable users or others to customize aspects of the computing environment. For example a user may desire to configure or install software, change an appearance, or otherwise customize the computing environment.

Computing environments often enable users to access and manipulate settings which affect the performance, presentation, operation, or other aspects of the computing environment. In some instances, a user may access and manipulate settings as a general user, an administrator, or at another level that may include options to conduct activities that are not available in other levels. In some instances, a user may escalate from a lower privilege to a higher privilege (e.g., administrator) to conduct an activity.

When computing in an environment with a higher privilege, a user may become increasingly more susceptible to inadvertently harming the computing environment. For example, the user may expose the computing environment to modification by malware or other software which may intentionally or unintentionally negatively modify the computing environment. Negative modification of the computing environment may cause the computing environment to stop functioning properly, display error messages, or lose valuable data.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Techniques, systems, and apparatuses for conveying privilege escalation to a user are disclosed. In one or more aspects, a privilege escalation request is initiated in a first operating environment. The first operating environment may foreshorten to reveal a second operating environment associated with the privilege escalation. The second operating environment includes a continuous visual presentation to alert the user of the privilege escalation. A user may complete one or more privileged activities in the second operating environment before returning to the first operating environment.

In further aspects, a user interface may include a first portion and a second portion. The first portion may include a foreshortened representation of a first operating environment associated with a lower privilege. The second portion may include a second operating environment associated with an escalated privilege. The second operating environment may include a visual presentation depicting the inner working of a device to suggest to the user an importance of the escalated privileged environment.

Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The same reference number in different figures refers to similar or identical items.

FIG. 1 is an illustrative environment that may be used to implement one or more embodiments of conveying privilege escalation to users.

FIG. 2 shows an illustrative interface that enables a user to enter a privilege escalation environment.

FIG. 3 shows an illustrative interface of a privilege escalation environment.

FIG. 4 shows another illustrative interface of a privileged escalation environment that may be implemented to alert a user of a privilege escalation activity.

FIG. 5 shows still another illustrative interface of a privileged escalation environment that may be implemented to alert a user of a privilege escalation activity.

FIG. 6 shows an illustrative flow diagram of at least one embodiment of conveying privilege escalation to a user.

FIG. 7 shows an illustrative flow diagram of one or more embodiments of conveying privilege escalation to a user by providing a privilege escalation environment.

FIG. 8 is a block diagram illustrating embodiments of modules in a privilege escalation manager residing in system memory from FIG. 1.

FIG. 9 shows a block diagram of an illustrative computing device which may be part of the system show in FIG. 1.

### DETAILED DESCRIPTION

Computing devices typically include computing environments, such as operating systems, that often have “privileged” and “non-privileged” modes of operation. Often, these computing environments will prompt the user for permission to go from a non-privileged mode to a privileged mode. In some instances, the computing device may request the user to undertake additional assurances before implementing a privilege escalation. For example, the user may be presented with a dialog box which displays a message to confirm a user's activity.

In some instances, the user may desire to remain in a privileged state for an extended period of time. For example, when a user engages in a pattern of software installation or configuration, an operating system may repeatedly prompt the user to provide a privilege permission. This repeated prompting may cause undesirable delays, be negatively received by the user, or be undesirable for other reasons. In some instances, the operating system may place the user into a persistent privileged mode until the user or operating system completes the software installation.

In addition to annoying, or otherwise negatively affecting a user experience during a privilege change, current systems are typically limited to a momentarily alerting a user. A one time alert or confirmation of a privilege change may be ineffective when the user spends a prolonged period of time in the privileged state. In addition, a privilege escalation indicator must be effective enough to keep the user vigilant during activities in the privileged state, while requiring minimal or no user action (e.g., confirmation request, dialog prompts, messaging, etc.) while the user conducts activities in the privileged state.

When providing a visual indicator to a user to alert the user of a privileged mode, a designer may be cognizant of the state of mind the indicator may induce in the user. Overly powerful “WARNING!” indicators may scare the user and dissuade the user from proceeding with an otherwise proper activity, while bland “go ahead” indicators may not make the user cautious enough. Finally, a termination of the privileged state may be clearly presented to the user.

### Illustrative Environment

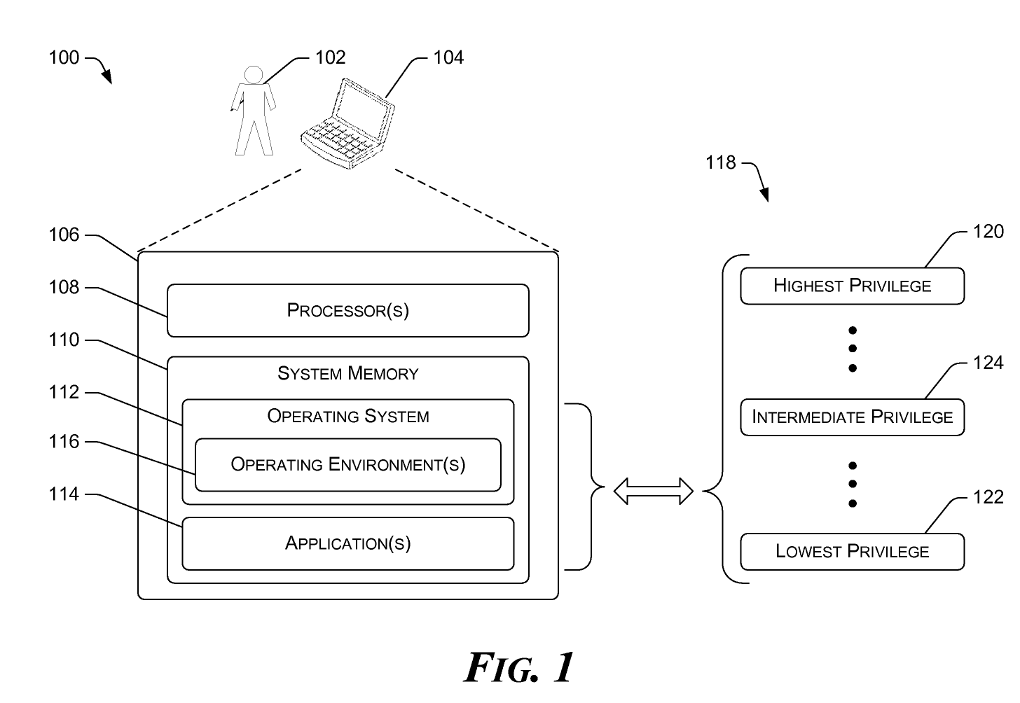

FIG. 1 is an illustrative environment 100 that may be used to implement one or more embodiments of conveying privilege escalation to users. The environment includes a user 102 and a computing device 104. The computing device 104 may be a personal computer, a laptop computer, a mobile telephone, a digital telephone, a personal data assistant (PDA), an audio/video device, or another device which operates using modifiable software residing on system memory.

The computing device 104 may include a number of components 106. At a basic level, the components may include at least one processing unit 108 and system memory 110, among other possible components. The system memory 110 may include an operating system 112 and applications 114. The operating system 112 may be any operating system that provides a computing environment to enable the user 102 to access, control, or manipulate data using the computing device 104. The applications 114 may include program modules and/or program data which may be executed in conjunction with the operating system 112 to access, control, or manipulate data.

In accordance with one or more embodiments of the disclosure, the operating system 112 may include an operating environment 116. The operating environment 116 may provide the context in which the user 102 interacts with the computing device 104. For example, the operating environment 116 may be a distinct user interface which includes a background, an active portion for conducting computing activities (e.g., executing an application, etc.) and an inactive portion which may display information (either dynamically or statically) or may be aesthetic and not intended to display information.

The operating system 112, including the operating environment 116 and the applications 114, either singly or in combination, may be mapped to a privilege spectrum 118. The privilege spectrum 118 may include a highest privilege 120 (e.g., administrative privilege, master privilege, etc.) and a lowest privilege 122 (e.g., basic user privilege, guest privilege, default privilege, etc.). The highest privilege 120 may enable a user to control more aspects of the computing device as compared to the lowest privilege 122, however, concurrently making the computing device 104 more vulnerable to inadvertent harm. In some embodiments, a least one intermediate privilege 124 may be included in the privilege spectrum 118. The privilege spectrum 118 may be applied to the user 102 or the computing device 104.

In one or more embodiments, aspects of the operating system 112 and the applications 114 may be mapped to the privilege spectrum 118. For example, when the user 102 desires to modify an attribute of the operating system 112, the operating system may reference the privilege spectrum 118 to ensure the user 102 is authorized to make the requested modification. If the user is not privileged to undertake the requested modification (i.e., the privilege is currently lower than required for the requested modification), the user 102 may escalate the privilege and then complete the requested modification.

In accordance with one or more embodiments, the operating environment 116 may be mapped to the privilege spectrum 118 to provide an indicator to the user 102 of the state of the privilege in the privilege spectrum 118. For example, a first operating environment may be mapped to the lowest privilege 122 and a second privilege may be mapped to the highest privilege 120. Additional operating environments may be mapped to intermediate privileges, such as the intermediate privilege 124. In some embodiments, the first operating environment mapped to the lowest privilege 122 may be a default operating environment that the user 102 conducts the majority of his or her activities within while operating the computing device 104.

### Illustrative Interface

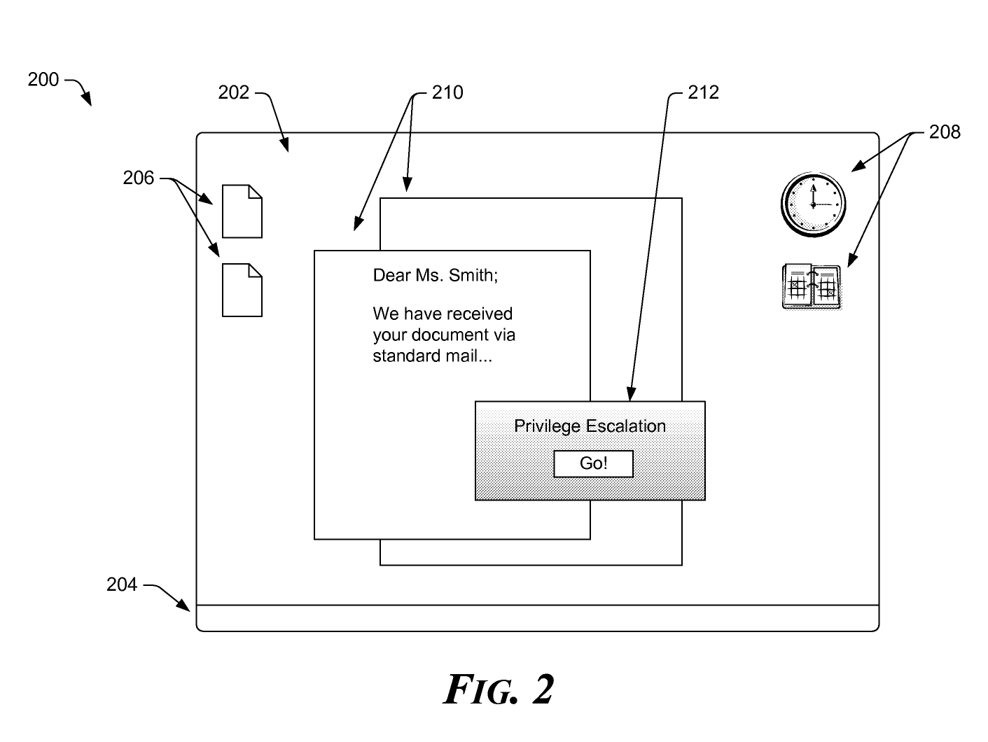

FIG. 2 shows an illustrative interface 200 that enables a user to enter a privilege escalation environment. The interface 200 includes a workspace 202 which facilitates user activity on the computing device 104. The workspace 202 may be divided into one or more layers or portions, which enable the user 102 to organize visual representations in the workspace. For example, the workspace 202 may include a base layer (i.e., a wallpaper layer) which is exposed unless other layers or objects conceal the base layer.

The workspace 202 may include a number of objects that enable the user 102 to conduct activities, extract information, or otherwise manipulate the computing device 104. As such, the workspace 202 may include a taskbar 204 to assist the user 102 in navigating through an infrastructure supported by the operating system 112. The workspace may optionally include icons 206 (e.g., folders, shortcuts, documents, etc.), programs 208 (e.g., gadgets, applications, etc.), and activities 210 (i.e., executing application interfaces), which the user 102 may initiate, explore, or manipulate while interacting with the computing device 104.

In accordance with one or more embodiments, the workspace 202 may enable presentation of a privilege escalation prompt 212 which may enable the user 102 to change a privilege prior to undertaking a privileged activity. The privilege escalation prompt 212 may enable the user 102 to initiate a privilege change which in turn may initiate a conveyance of an escalated privilege to the user 102.

An operating environment, such as the operating environment 116 of FIG. 1, is a particular arrangement or configuration of at least a portion of the workspace 202 which is perceived by the user 102. Typically, the operating environment 116 includes a general look and feel which is constrained by the operating system 112, and that may be manipulated, customized, or otherwise changed by the user within predetermined constraints managed by the operating system.

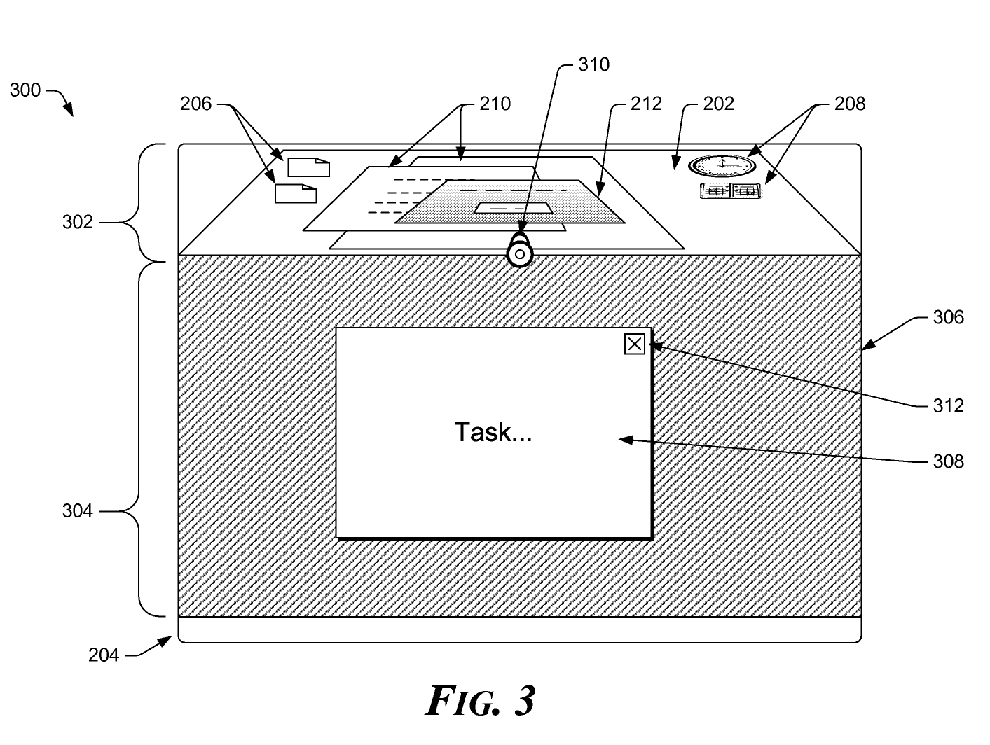

FIG. 3 shows an illustrative interface 300 of a privilege escalation environment. One or more embodiments include a visual indicator and interactive mode that communicates to the user 102 that he or she is undertaking a significant action. When the operating system 112 puts the user into an elevated privilege mode for a persistent period of time, or the user requests the elevated privilege mode, the operating system may foreshorten the current (or first) operating environment and display a second operating environment including graphics that provides a visual cue that the user is doing something more appropriate for an elevated privilege. The graphics may communicate to the user that he or she is manipulating the internal bits that control the computing device 104 rather than just using the computing device under ordinary (lower privilege) circumstances.

The interface 300 includes a first portion 302 and a second portion 304. The first portion 302 includes a foreshortened rendering of the operating environment prior to an escalation in privilege. For example, the first portion 302 may include the icons 206, the programs 208, the activities 210, and even the privilege escalation prompt 212 which were previously displayed in the operating environment before the escalation in privilege. In one or more embodiments, the first portion may remain active and dynamically update information. For example, the hands of a clock may continue to move or a media player may continue to output audio and/or video via the computing device.

The second portion may provide a second workspace 306 that includes graphics which communicate to the user 102 that he or she is operating in an escalated privilege state rather than just using the computing device under lower privilege circumstances. For example, the workspace 306 may include a graphical cue to alert and remind the user 102 of the privileged state without requiring further action by the user 102, such as receiving and closing intermittent dialog messages.

The second portion may also enable the user 102 to conduct a privileged activity 308. For example, the user may operate in the first operating environment with the interface 200 of FIG. 2 when the user decides to change a system setting. The user may be presented with, and accept, the privilege escalation prompt 212. Next, the interface 200 may transition to the interface 300 which includes the first portion 302 and the second portion 304. The second portion 304 may include the privileged activity 308 which was previously requested by the user. The user 102 may then conduct the privileged activity 308 with the continual reminder of the workspace 306 which indicates that the user is operating in an escalated privilege state.

When the user 102 completes the privileged activity 308, the user may revert from the interface 300 having the escalated privilege state to the interface 200 associated with a lower privilege state. In some embodiments, the user 102 may terminate the escalated privilege by clicking, or otherwise selecting, a latch 310 which may initiate the transition from the interface 300 to the interface 200. The latch 310 may be a graphical representation that provides an intuitive option for the user. Additionally or alternatively, some embodiments may include other graphical representations, text, or other features that enable the user 102 to return to the interface 200. In further embodiments, the user may terminate interface 300 by closing the privileged activity 308, such as by selecting a close button 312.

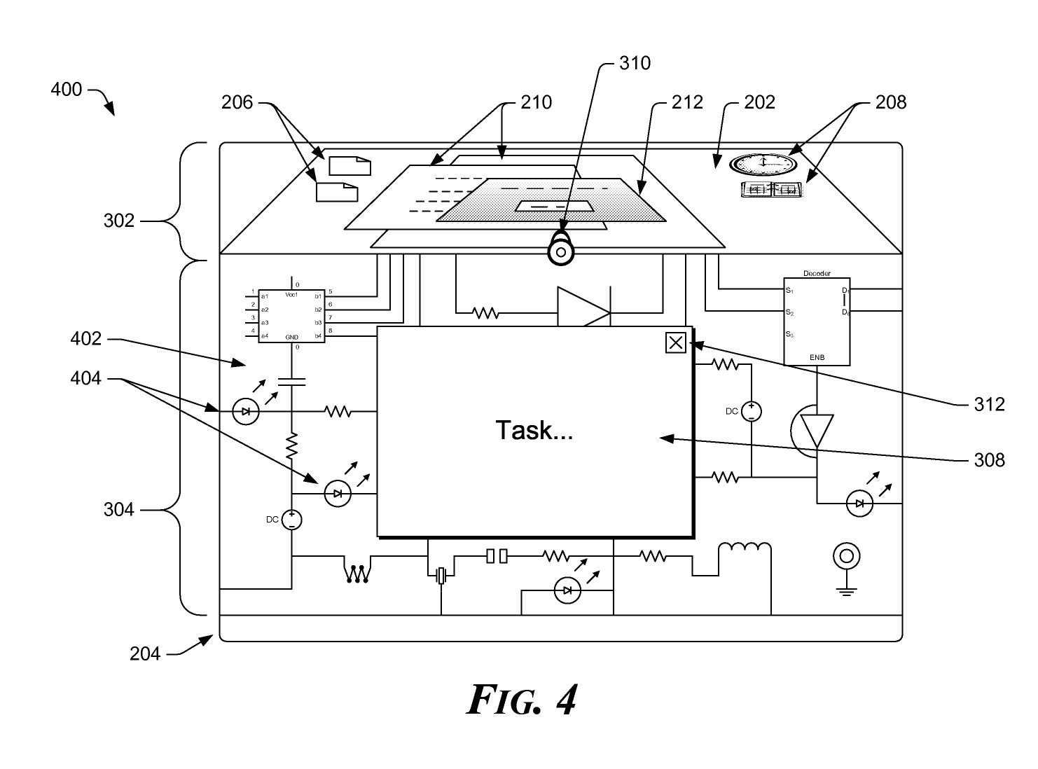

FIG. 4 shows another illustrative interface 400 of a privileged escalation environment that may be implemented to alert a user of a privilege escalation activity. The interface 400 includes a graphical representation 402 to indicate an escalation of privilege to the user 102. When switching to a privileged mode, it is important to provide a visual indicator to the user 102 that indicates they have begun operating at high privilege and is advised to be careful of what they do in the privileged mode.

As shown in FIG. 4, the graphical representation 402 depicts inner workings of a computing device, such as the computing device 104. In one or more embodiments, the graphical representation 402 may be directly associated with the computing device 104. Alternatively, the graphical representation 402 may be generic to multiple computing devices, such as a graphical representation of a basic circuit board. Further embodiments may include the graphical representation 402 having internal structures of the computing device, such a device frame, components (e.g., memory drives, fans, etc.) or other features that may assist the user 102 to associate the graphical representation with a privilege escalation.

In one or more embodiments, the graphical representations 402 may be dynamic. The graphical representations may include components 404, such as light emitting diodes (LEDs), fans, gauges, etc., which change in visual presentation to enhance the graphical representation 402. For example, LEDs may flash, fans may spin, wires may spark, or other visual presentations may occur which enhance the graphical representation 402.

The transition from a first operating environment, such as interface 200 of FIG. 2, to another operating environment associated with a privilege escalation, such as interface 400, may include animation. For example, the operating environment in a lower privilege may move up and away to the first portion 302, such as to simulate a cover opening to reveal the inner workings of the computing device 104 via the graphical representation 402 in the second portion 304. Animation may solidify a conveyance of the privilege escalation to the user in an intuitive manner.

In one or more embodiments, the first operating environment associated with the lower privilege (e.g., the interface 200) may reside in other locations other than the first portion 302 or may be represented in other configurations without departing from the spirit and scope of the disclosure. For example, the first operating environment may be reduced in size and placed in a corner of the second operating environment. In additional embodiments, the user 102 may adjust the location of the first operating environment.

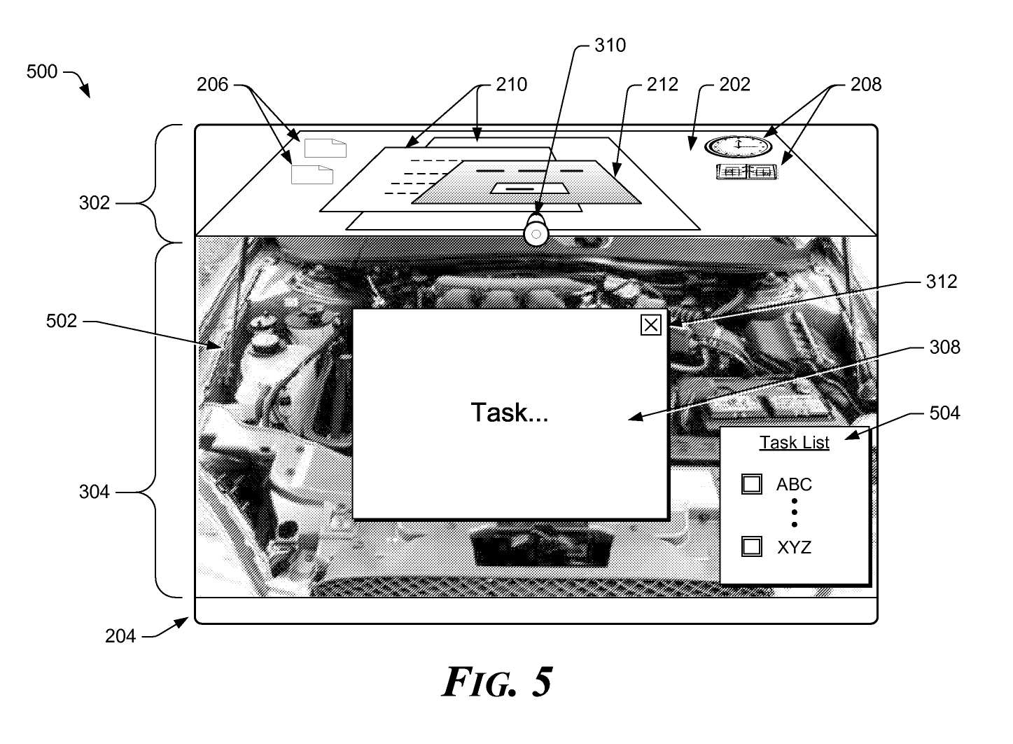

FIG. 5 shows still another illustrative interface 500 of a privileged escalation environment that may be implemented to alert a user of a privilege escalation activity. A graphical representation 502 includes a mechanical component graphics to indicate an escalation of privilege to the user 102. In one or more embodiments, the graphical representation 502 is a graphical representation of an engine. The first portion may be represented analogous to a hood of a vehicle which is opened to review the inner working of the apparatus. The graphical representation 502 may be dynamic and include visual presentations such as movement of components (e.g., belts, gears, fans, etc.) or other visual displays such as smoke, sparks, etc.

In accordance with one or more embodiments, the interface 500 may include a task list 504. The task list 504 may enable the user 102 to create, track, and complete, among other possible uses, tasks which the user desires to engage in while in the privileged environment. For example, the user 102 may desire to install a number of software updates while operating in a privileged escalation environment. The task list 504 may list each task (e.g., installation) and may be updated, either automatically or by the user, upon completion of the task. In some embodiments, the completion of the task list 504 may result in the termination of the privilege escalation. Additionally or alternatively, the latch 310, a timer expiration, or other events, may terminate the privilege escalation.

### Illustrative Operation

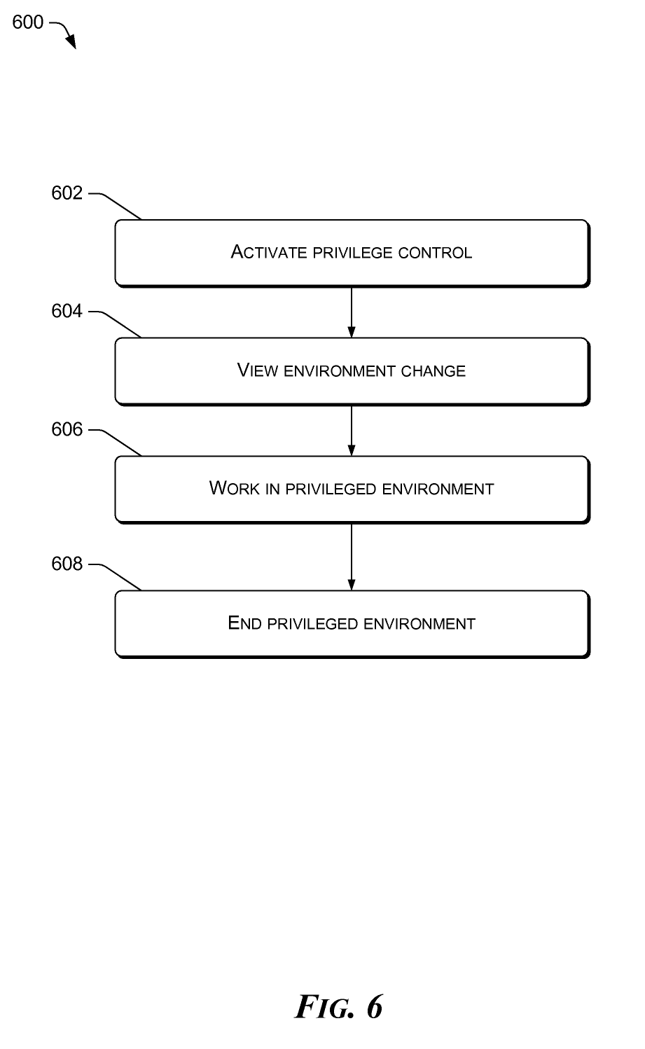

FIG. 6 shows an illustrative flow diagram of a process 600 of conveying privilege escalation to a user. The process 600 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described through this disclosure, in addition to process 600, shall be interpreted accordingly.

As shown in FIG. 6, the user 102 via the client 104 activates a privilege control at 602. For example, the user may select an option to modify an attribute of the operating system 112, such as by accepting the privilege escalation prompt 212.

At 604, the user 102 may view an environment change as displayed on the computing device 104. For example, the operating system 112 may cause the computing device 104 to display an animated transition from a first operating environment (e.g., the interface 200, etc. ) to a second operating environment (e.g., the interface 300, the interface 400, etc.). The animation may be accompanied by sound or other sensory messages, either alone or in combination, which may be perceived by the user 102.

The user 102 may conduct activities, work, or other tasks in the privileged environment at 606. For example, the user may modify an attribute of the operating system 112. At 608, the privileged environment may be terminated. For example, the privilege task may be completed at 606 which automatically ends the privileged environment. Additionally or alternatively, the user 102 may take an action to end the privileged environment such as by selecting the latch 310 of FIG. 3.

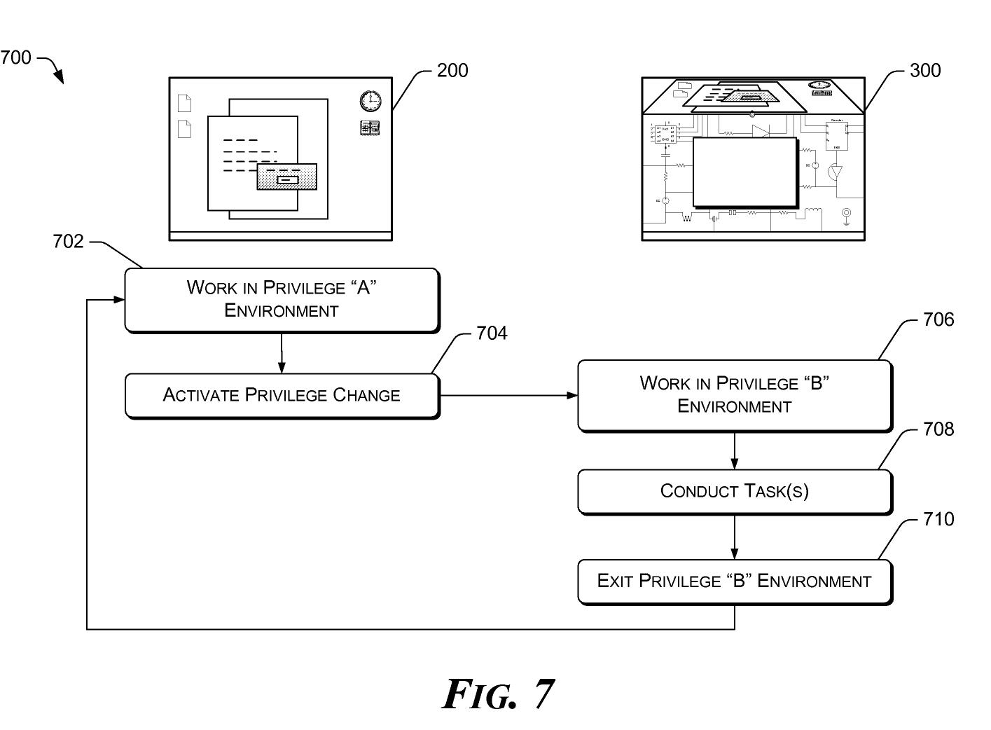

FIG. 7 shows an illustrative flow diagram of a process 700 of conveying privilege escalation to a user by providing a privilege escalation environment. The process 700 includes operations which may occur in a first environment, such as by the interface 200, and operations which may occur in a second environment, such as by the interface 300. At 702, work is conducted in the first environment associated with a lower privilege. At 704, a privilege escalation is activated, such as by activating the privilege escalation prompt 212.

At 706, work is conducted in the second environment associated with an escalation in privilege. At 708, the user 102 may conduct specific tasks in the second environment, such as tasks on the talk list 504 of FIG. 5. At 710, the user exits the second environment and returns to the first operating environment (e.g., the interface 200). In one or more embodiments, animation or other effects may be used during the transitions to operation 706 or from operation 710. For example, after operation 710, the interface 200 of FIG. 2 may move over the second portion 304 to simulate the closing of a cover which protects the inner workings of the computing device 104, thus representing a return to a lower privileged (and more secure) environment.

### Illustrative Computing Environment

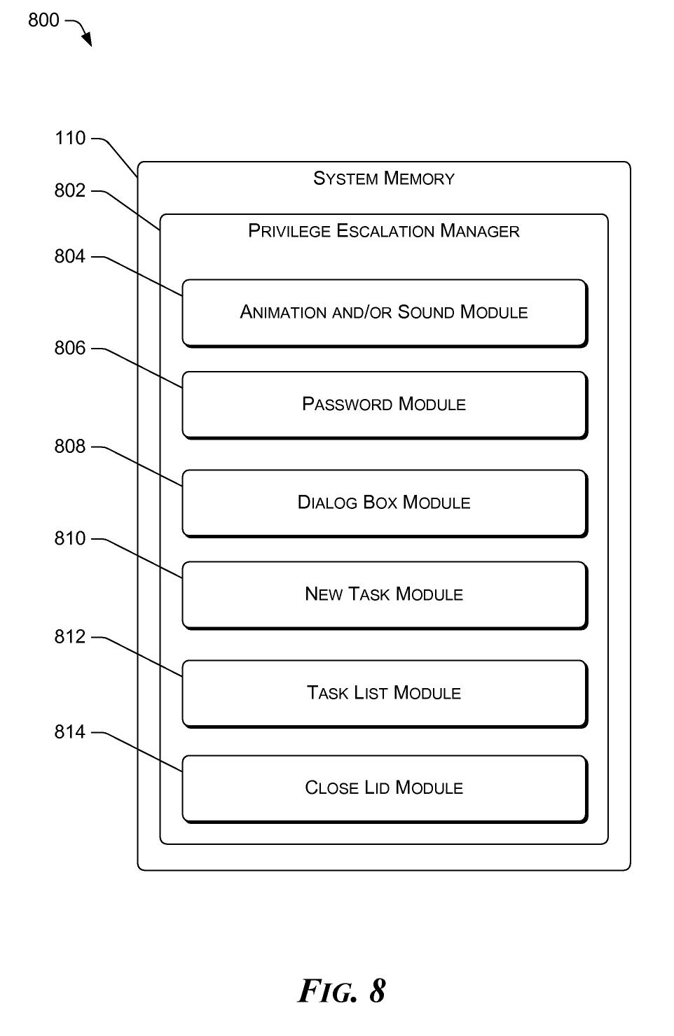

FIG. 8 is a block diagram 800 illustrating embodiments of modules in a privilege escalation manager 802 residing in system memory 110 from FIG. 1. The escalation manager 802 may include a number of modules which may be implemented to enhance the privilege escalation interface as described herein. The modules may be selectively implemented, such that only a portion of the modules are used in an interface.

An animation and/or sound module 804 may provide sensory effects to the user 102 during a transition to or from the privilege escalation environment. Additionally or alternatively, the animation and/or sound module 804 may provide sensory effects to the user 102 in the privilege escalation environment, such as by providing a visual presentation to the user (e.g., sparks, movement, flashing lights, etc.).

A password module 806 may enforce authorization before, during, and/or after a privilege escalation process. A dialog box module 808 may provide information to the user 102, such as the privilege escalation prompt 212. A new task module 810 may allow the user to select a task to be completed in a privilege escalation environment. A task list module 812 may provide a task list, such as the task list 504, to allow the user 102 to create, track, and complete, among other possible uses, tasks which the user desires to occur while in the privileged environment. Finally, a close lid module 814 may enable the user to terminate a privilege escalation environment, such as by allowing the user to select and/or activate the latch 312.

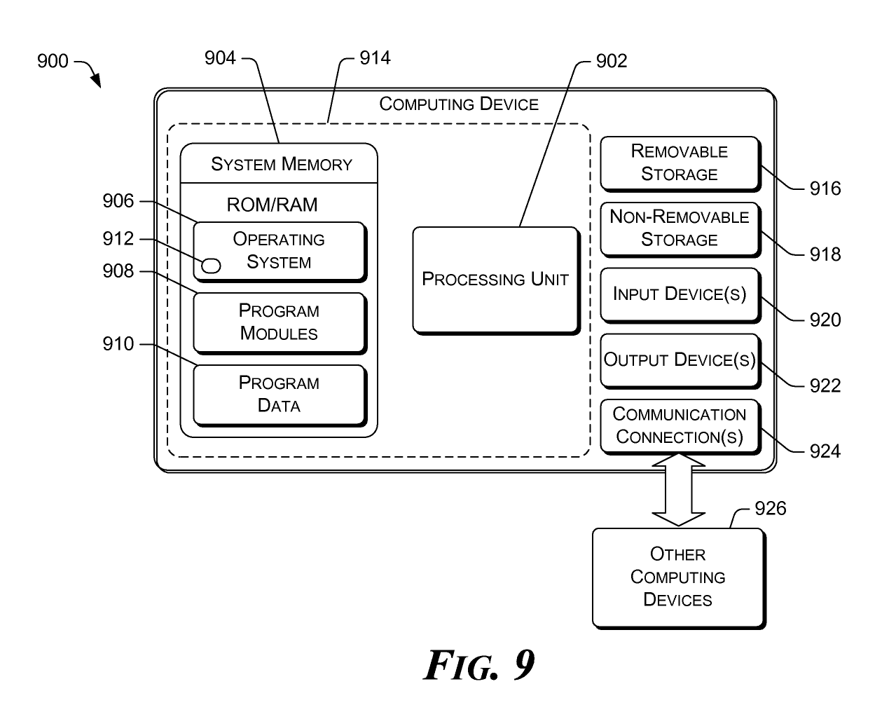

FIG. 9 shows a block diagram of an illustrative computing device which may be part of the system show in FIG. 1. For example, the computing device 104 of FIG. 1 may be implemented on the representative computing device 900. However, it will readily be appreciated that the various embodiments of the selective networked resource techniques and mechanisms may be implemented in other computing devices, systems, and environments. The computing device 900 shown in FIG. 9 is only one example of a computing device and is not intended to suggest any limitation as to the scope of use or functionality of the computer and network architectures. The computing device 900 is not intended to be interpreted as having any dependency or requirement relating to any one or combination of components illustrated in the example computing device.

In a very basic configuration, the computing device 900 typically includes at least one processing unit 902 and system memory 904. Depending on the exact configuration and type of computing device, the system memory 904 may be volatile (such as RAM), non-volatile (such as ROM, flash memory, etc.) or some combination of the two. The system memory 904 typically includes an operating system 906, one or more program modules 908, and may include program data 910. The operating system 906 includes a component-based framework 912 that supports components (including properties and events), objects, inheritance, polymorphism, reflection, and provides an object-oriented component-based application programming interface (API). The device 900 is of a very basic configuration demarcated by a dashed line 914. Again, a terminal may have fewer components but will interact with a computing device that may have such a basic configuration.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 916 and non-removable storage 918. Computer storage media may include volatile and nonvolatile, removable and non-removable media implemented in any method or technology for storage of information, such as computer readable instructions, data structures, program modules, or other data. The system memory 904, the removable storage 916 and the non-removable storage 918 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 900. Any such computer storage media may be part of the computing device 900. The computing device 900 may also have input device(s) 920 such as keyboard, mouse, pen, voice input device, touch input device, etc. Output device(s) 922 such as a display, speakers, printer, etc. may also be included. These devices are well know in the art and are not discussed at length here.

The computing device 900 may also contain communication connections 924 that allow the device to communicate with other computing devices 926, such as over a network. These networks may include wired networks as well as wireless networks. The communication connections 924 are one example of communication media. The communication media may typically be embodied by computer readable instructions, data structures, program modules, etc.

It is appreciated that the illustrated computing device 900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. A method for conveying privilege escalation, the method comprising:
receiving a privilege escalation request;
transitioning from a first environment associated with a first privilege to a second environment associated with a second privilege;
sending display signals to cause the second environment to display a representation of inner workings of a device to visually represent a privilege escalation;
providing an activity in the second environment using the second privilege; and
transitioning to the first environment when the second privilege is terminated.

2. The method of claim 1, wherein the transitioning from a first environment associated with a first privilege to a second environment associated with a second privilege includes foreshortening the first environment for display in the second environment.

3. The method of claim 2, wherein the foreshortened first environment is dynamic.

4. The method of claim 2, wherein the foreshortened first environment includes a visual representation of a cover of the second environment, the cover being open to reveal the second environment.

5. The method of claim 4, wherein the sending display signal to cause the second environment to display the representation of inner workings of the device include the representation of at least one of computing components and mechanical components.

6. The method of claim 1, wherein the transitioning from the first environment to the second environment includes animating the transition by having the first environment open to reveal the second environment.

7. The method of claim 1, wherein the first environment is foreshortened to represent a cover of a compartment of an apparatus represented by the second operating environment, the apparatus at least one of a computing device and a vehicle.

8. The method of claim 1, wherein the second privilege is higher than the first privilege.

9. One or more computer readable media storing computer-executable instructions that, when executed by a computer, perform acts comprising:
causing the display of a first environment associated with a first privilege;
receiving a request to change a privilege from the first privilege to a second privilege; and
causing the display of a second environment associated with the second privilege, the second environment being active during the duration of the second privilege, the second environment include a visual presentation associated with the second privilege.

10. One or more computer readable media as in claim 9, wherein the visual presentation associated with the second privilege include inner workings of at least one of a computing device and a mechanical device.

11. One or more computer readable media as in claim 9, wherein the causing the display of the second environment includes causing the display of a foreshortened first environment, the foreshortened first environment represented a cover positioned to reveal the second environment.

12. One or more computer readable media as in claim 11, wherein the foreshortened first environment includes a latch, the latch enabling a reversion from the second privilege to the first privilege.

13. One or more computer readable media as in claim 9, wherein the visual presentation associated with the second privilege includes a dynamic image.

14. One or more computer readable media as in claim 9, further comprising reverting to the first environment when the second privilege is terminated.

15. A user interface, comprising:
a first portion representing a condensed workspace image prior to entering a privileged state; and
a second portion enabling a user to conduct a privileged activity, the second portion having a workspace defined by:
a privileged task in the foreground, and
a privilege escalation graphic in the background.

16. The user interface of claim 15, wherein the privileged escalation graphic is one of an engine or a circuit board.

17. The user interface of claim 15, further comprising a third portion having a task list including a plurality of privileged tasks for the user to conduct in the work space of the second portion.

18. The user interface of claim 15, wherein the first portion includes a latch.

19. The user interface of claim 15, wherein the first portion is configured to simulate a hood which opens to reveal the second portion.

20. The user interface of claim 15, wherein the privileged escalation graphic includes animation.
